(19) United States
(12) Patent Application Publication
(10) Pub. No.: US 2026/0309288 A1
(43) Pub. Date: Oct. 8, 2026

(54) LIGHT ASSEMBLY

(71) Applicant: VISTA Manufacturing, Inc., Elkhart, IN (US)

(72) Inventors: Alexander M. Tolen, Elkhart, IN (US); Michael A. Rink, Goshen, IN (US)

(21) Appl. No.: 19/201,246

(22) Filed: May 7, 2025

Related U.S. Application Data
(60) Provisional application No. 63/784,461, filed on Apr. 7, 2025.

(51) Int. Cl. F21S 4/24; F21Y 115/10

(52) U.S. Cl. CPC F21S 4/24; F21Y 2115/10

(57) ABSTRACT

A light assembly for covering an extrusion for an RV-panel includes a light strip having a plurality of light sources, an elongated body having a base for mounting the assembly in the extrusion and a light transmitting portion joined or formed with the base. The transmitting portion includes an outwardly facing surface when mounted in the extrusion, with the strip being in the body and emitting light, when powered, into and through the light transmitting portion wherein light is output from the outwardly facing surface. The body has recessed channels on opposed sides of the body between the light transmitting portion and the base for receiving and sealing against inwardly facing flanges of the extrusion. The base has a cross-section greater than the space between the ends of the inwardly facing flanges wherein when the base is inserted into the extrusion, the base will capture the body in the extrusion.

### BACKGROUND AND TECHNICAL FIELD

The present disclosure relates to light assemblies, and especially LED light assemblies.

In some applications, light assemblies are mounted using a clip. However, in some cases, the clips can add complexity to the installation. Further, the light assemblies may not appear fully integrated with the clip and, hence, distract from the overall aesthetic appearance of the light assembly.

RV panels are often joined by metal extrusions that are fastened to the RV using screws. To cover the screws, an extruded plastic cover may be inserted into the metal extrusion. These covers, however, provide little functionality other than their concealment function.

Accordingly, the present disclosure provides a light assembly that can provide a concealment function as well as sealing function for the metal extrusions (that join the exterior RV panels) and, moreover, can provide an aesthetic and customization function.

### SUMMARY

Accordingly, a light assembly is disclosed that can provide a cover function but that also provides a light function to enhance and customize the aesthetics of the exterior of an RV.

In one embodiment, a light assembly is disclosed for covering a metal extrusion for an RV panel. The metal extrusion has a web, through which fasteners extend to secure the metal extrusion to an RV, and a pair of inwardly facing flanges that extend from the web which form a space between the distal ends of the pair of inwardly facing flanges to form an access opening to the web. The light assembly includes a flexible elongated body having a base for mounting the light assembly in the metal extrusion, an enclosure for holding a light strip, and a light transmitting portion joined or formed with the base for emitting light from the light strip when powered, which has an outwardly facing surface when mounted in the metal extrusion. The flexible elongated body includes recessed channels on opposed sides of the elongated body between the light transmitting portion and the base for receiving and sealing against the inwardly facing flanges of the metal extrusion when the base is inserted into the metal extrusion. Further, the base has a cross-sectional dimension sized to be greater than the space between the ends of the inwardly facing flanges wherein when the base in inserted into the extrusion, the base will capture the flexible elongated body in the extrusion. The light assembly also includes a light strip with a plurality of light sources, which is located in the enclosure for emitting light into and through the light transmitting portion wherein, when powered, light emitted from the light sources is output from the outwardly facing surface of the elongated body.

In one aspect, the outwardly facing surface of the elongated body has a cross-section sized to extend over the inwardly facing flanges of the metal extrusion when the base of the flexible elongated body is captured in the metal extrusion. For example, the cross-section of the outwardly facing surface may be sized to fully extend over and cover the inwardly facing flanges of the metal extrusion when the base of the flexible elongated body is captured in the metal extrusion.

In any of the above, the light assembly may be configured to have a first state wherein the outwardly facing surface of the light transmitting body has a first color to match a color of the metal extrusion when the light sources on the light strip are not powered and a second state to no longer match the color of the metal extrusion when the light strip is powered wherein instead light is emitted from the outwardly facing surface of the light transmitting body.

In one aspect, the flexible elongated body comprises a silicone elongated body. Further, the outwardly facing surface of the elongated body is translucent.

In one embodiment, the flexible elongated body comprises first and second silicone materials, with the first silicone material being substantially transparent, and the second silicone material being translucent and forming the outwardly facing surface.

In another embodiment, the flexible elongated body comprises first and second materials, with the first material comprising a silicone material and being substantially transparent, and the second material comprising a translucent plastic, such as PVC, and forming the outwardly facing surface.

In any of the above, the light strip comprises a flexible light circuit board.

In any of the above, the base has a channel sized and arranged to straddle the fasteners that are used to secure the metal extrusion to the RV.

In any of the above, the base may have a pair of bearing surfaces straddling the channel.

In another embodiment, a light assembly system includes a metal extrusion and a light assembly. The metal extrusion is for connecting an RV panel to the frame of the RV. The metal extrusion has a web and a pair of inwardly facing flanges extending from the web, with the web providing a surface through which fasteners extend to secure the metal extrusion to the RV. The pair of inwardly facing flanges having distal ends and a space between the distal ends to form an access opening to the web. The light assembly includes a light strip with a plurality of light sources and a flexible elongated body. The elongated body has a base for mounting the light assembly in the metal extrusion and a light transmitting portion joined or formed with the base, which forms an outwardly facing surface when mounted in the metal extrusion. The light strip is in the elongated body for emitting light into and through the light transmitting portion, wherein, when powered, light emitted from the light sources is output from the outwardly facing surface of the elongated body. The flexible elongated body forms an upper portion and a lower portion, with the lower portion including the base, and the upper portion including the outwardly facing surface. The upper portion and the lower portion each have a cross-sectional dimension greater than the space between the distal ends of the pair of inwardly facing flanges. The flexible elongated body includes recessed channels on opposed sides of the elongated body between the upper portion and the lower portion, and wherein when the base is in inserted into the extrusion, the recessed channels will receive and sealingly engage the pair of inwardly facing flanges and the base will capture the flexible elongated body in the extrusion.

In one embodiment, the outwardly facing surface of the elongated body has a cross-section sized to fully extend over and cover the inwardly facing flanges of the metal extrusion when the base of the flexible elongated body is captured in the metal extrusion.

In other aspects, the metal extrusion has a colored exterior surface, and the light assembly is configured to have (1) a first state wherein the outwardly facing surface has a first color to generally match the colored surface (the colors appear to be the same to the naked eye) of the metal extrusion when the light sources on the light strip are not powered and (2) a second state when the light strip is powered to no longer match the colored surface of the metal extrusion wherein instead light is emitted from the outwardly facing surface.

In any of the above systems, the flexible elongated body comprises first and second materials, with the first material comprising a silicone material and being substantially transparent, and with the second material comprising a second transparent silicon material or a plastic, such as a flexible polyvinylchloride (PVC), and forming the outwardly facing surface.

In any of the above systems, the light strip comprises a flexible light circuit board.

In any of the above systems, the base has a channel sized and arranged to straddle the fasteners that are used to secure the metal extrusion to the RV.

In any of the above systems, the base may have a pair of bearing surfaces straddling the channel.

### BRIEF DESCRIPTION OF THE DRAWINGS

FIG. 1 is a perspective view of a light assembly system;

FIG. 2 is cross-section view of the light assembly system of FIG. 1;

FIG. 3 is a cross-section view of the light assembly of FIG. 2;

FIG. 4 is a cross-section of the extrusion of FIG. 1;

FIG. 5 is a cross-section view of a light assembly system of another embodiment of a light assembly system; and

FIG. 6 is perspective view of the extrusion of FIG. 5.

### DETAILED DESCRIPTION

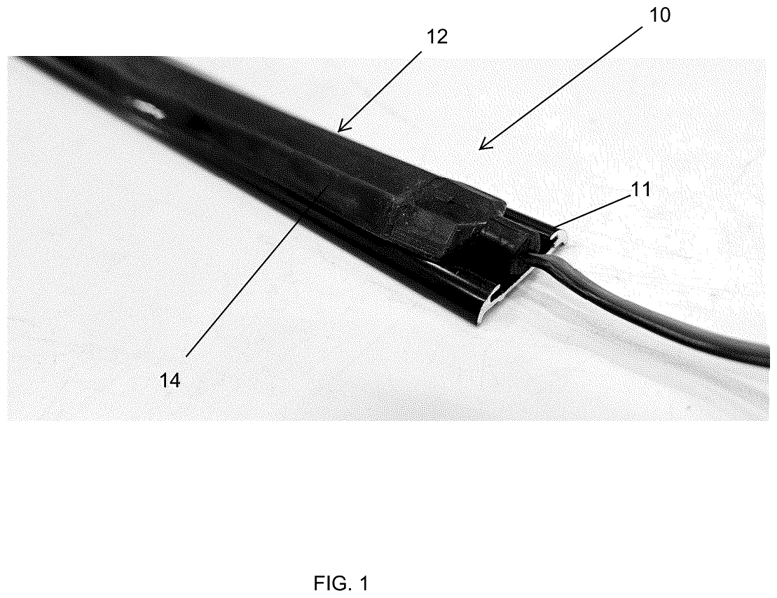

Referring to FIG. 1, the numeral 10 generally designates a light assembly system. Light assembly system 10 includes an extrusion 11, which is used to mount panels in a recreational vehicle (RV), and a strip light assembly 12, but without any of the mounting clips normally associated with mounting strip light assemblies, which greatly simplifies the installation process. As will be more fully described below, light assembly 12 is configured so that it can replace a cover for the extrusion to provide the lighting function associated with strip lighting assemblies. In addition, as will be more fully described below, the light assembly 12 of the light assembly system 10 may be configured to give the appearance of being part of the extrusion and, hence, to mimic a cover or trim piece with the lighting function only being visible when the light assembly is powered.

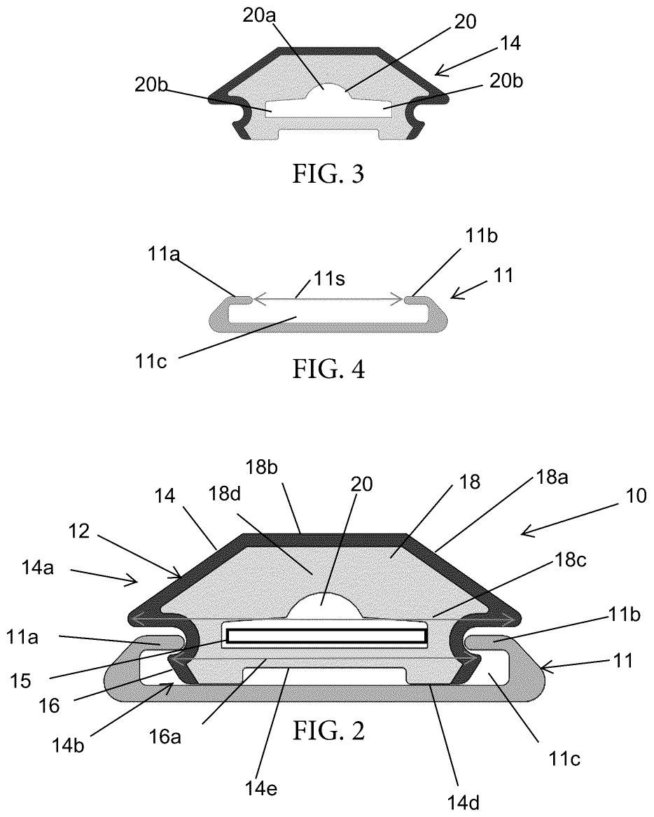

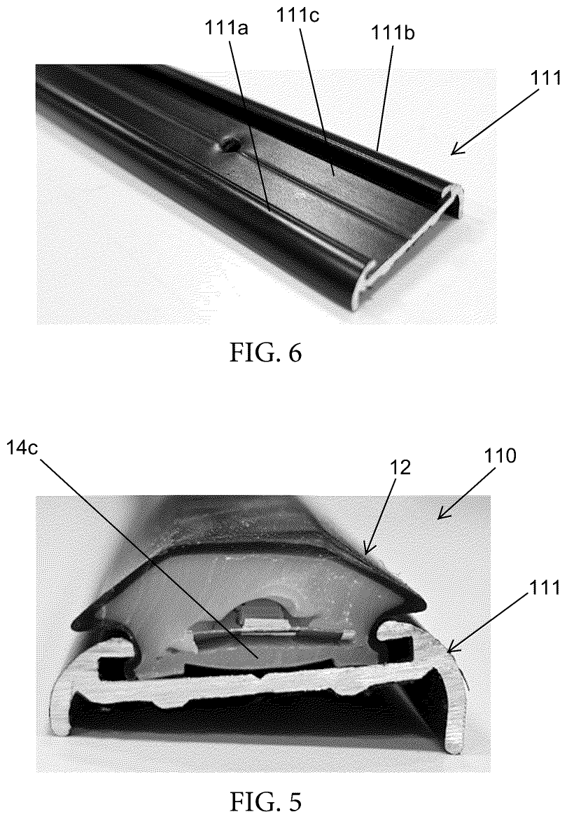

As best seen in FIGS. 1-3, light assembly 12 includes an elongated body 14 and a light strip 15 (FIG. 2), which is supported in the elongated body 14 to direct light from the light assembly 10. Elongated body 14 includes a base 16 for mounting the light assembly 12 in the extrusion 11 and a light transmitting portion 18 joined or formed with the base 16 for emitting light from the light assembly, which includes an outwardly facing surface 18a through which light is emitted when the light strip is powered. Optionally, elongated body 14 includes an enclosure 20 between the base 16 and the light transmitting portion 18, which forms a cavity in elongated body 14 for receiving the light strip. In the illustrated embodiment, light transmitting portion 18 is a trapezoidal-shaped portion and, therefore, has a generally horizontal upper surface 18b; however, it should be understood that the shape of the light transmitting portion 18 may vary.

To mount the elongated body 14 in the extrusion 11, elongated body 14 includes a pair of opposed recessed channels 22 on opposed sides of the elongated body 14 between an upper portion 14a, which includes the light transmitting portion 18, and a lower portion 14b, which includes the base 16. Recessed channels 22 are sized and configured for receiving and sealing against the inwardly facing flanges 11a, 11b of the metal extrusion 11 when the base 16 is inserted into the channel 11c of metal extrusion 11. Further, the base 16 has a cross-sectional dimension 16a sized to be greater than the space 11s between the ends of the inwardly facing flanges 11a, 11b but smaller than the width of channel 11c of extrusion 11 wherein when the base 16 in inserted into the channel 11c of extrusion 11, the base 16 will capture the flexible elongated body in the extrusion.

In addition, the upper portion 14a, or outwardly facing surface 18a of the elongated body 14, has a cross-section sized greater than space 11s and further to extend over the inwardly facing flanges 11a, 11b of the metal extrusion 11 when the base 16 of the flexible elongated body 14 is captured in the channel 11c of metal extrusion 11. For example, the cross-section of the outwardly facing surface may be sized to fully extend over and cover the inwardly facing flanges 11a, 11b of the metal extrusion 11 when the base of the flexible elongated body is captured in the metal extrusion. In this manner, when viewed from the

As noted above, when base 16 is inserted into the channel 11c of extrusion 11, base 16 is captured in the metal extrusion. This may be achieved by compressing the base 16 to a more compact configuration so that it can pass between the inwardly facing flanges 11a, 11b and through the space 11s of extrusion 11 and once inserted is allowed to then return to its uncompressed state. Further, this may be achieved by elastic deformation and/or plastic deformation depending on the material or materials forming the elongated body.

In one embodiment, the amount of compression may be simply enough to allow the elongated body to be tilted so that one of the flanges 11a, 11b can be inserted into a corresponding recessed channel and then the elongated body 14 rotated so that less compression is needed to insert the remaining side of elongated body into the channel 11c of the extrusion. To facilitate this rotation, the recessed channels may be rounded as shown in FIG. 2. To accommodate this rotation the wight 16a of the base 16 may be sized so that it is smaller than the width of the channel 11c.

In one embodiment, elongated body 14 may comprise an extrusion formed from a resilient flexible material, such as silicone, with the outer layer of the extrusion being coextruded from a silicone that has a different opacity from the silicone forming the core of the elongated body, which forms the transparent outwardly facing surface. In this embodiment, the compression can be achieved entirely through elastic deformation.

In another embodiment, elongated body 14 may comprise an extrusion formed from a resilient flexible material, such as silicone, with the outer layer of the extrusion being coextruded from a polymer, such as plastic, including a flexible polyvinylchloride (PVC), which has a different opacity from the silicone forming the core of the elongated body, and which forms the transparent outwardly facing surface. In this embodiment, the compression may therefore be achieved through a combination of plastic/elastic deformation. In this manner, the elongated body may form a snap-fit connection with the extrusion.

As noted above, the light assembly 12 may be configured to create the same outward appearance (same apparent opacity and optionally same color) as the extrusion. Also, as noted above, elongated body 14 may be co-extruded from materials with different color and/or opacity. For example, the base 16 and light transmitting portion 18 may be formed from the same material, namely a silicone that is transparent. Both may have a layer or coating that is opaque and/or tinted (e.g., white, black, grey or any other color—or metallic) or treated to look like the extrusion, such as black or dark grey. The layer or coating on base 16 may terminate to leave the transparent silicone that forms the core uncovered to allow the cut lines of the light strip to remain visible from the underside of the light assembly, as noted below.

In either case, this creates a similar or the same outward appearance for both the base 16 and the light transmitting portion 18 (except, as noted, when the lights sources are powered).

As described above, light assembly 12 includes a light strip 15 for emitting light into and through the light transmitting portion 18 wherein, when powered, light emitted from the light strip is output from the outwardly facing surface 18a of the elongated body.

The light strip 15, which may be located in an enclosure 20 formed in elongated body 14, includes a plurality of longitudinally spaced light sources, such as LEDs, which are, for example, connected in series, and supported on light strip 15. Light strip 15 may comprise a flexible tape circuit board. The light strip 15 is supported in elongated body 14, so that the light sources face the light transmitting portion 18 to direct light into and from the outwardly facing surface 18a when powered. As would be understood the length of the light strip 15, and hence light assembly 12, may be varied and may be assembled from a plurality of discrete flexible circuit boards connected end to end depending on the desired length of the light assembly. Alternately, the light strip 15, as noted below, may be made from a flexible tape light circuit board whose length can be adjusted by cutting the tape at preset cut locations along its length, as would be understood by those skilled in the art. Therefore, light strip 15 may be one continuous printed circuit board or may be assembled from connected discrete printed circuit boards.

As noted above, the light assembly 12 may be configured to mimic the appearance of a cover or trim piece when the lights are not powered with the light transmitting portion 18 of the light assembly 12 only being distinguishable as a light assembly when the light assembly is powered. Stated another way, light assembly 12 may be configured to have a first state wherein the outwardly facing surface 18a of the light transmitting portion 18 appear to have a first opacity, for example, appear to have the same opacity and/or color as the extrusion, when the light sources on the light strip are not powered, and a second state when the light sources on light strip 15 are powered wherein the outwardly facing surface 18a of the light transmitting portion 18 appears translucent allowing light from the light strip to transmit outwardly from the light assembly 12 and, therefore, in contrast to the extrusion.

In one embodiment, the outwardly facing surfaces 18a of the light transmitting portion 18 may have a different color than the extrusion, though still opaque.

When provided with the same color, the elongated enclosure 14 as the extrusion, the light assembly appears to be an extension of the extrusion and from some angles monolithic with the extrusion when the light sources are not powered and, hence, light assembly 12 looks like a cover or trim.

As noted above, enclosure 12 has a light transmitting portion 18 and a base 16. The interface between the two may vary. Referring again to FIG. 2, light transmitting portion 18 enclosure portion 20a and two opposed lateral portions 20b that extend outwardly from the central portion 20a of the enclosure 20. The height of the opposed lateral portions 20b is sufficient to receive the opposed edges of the light strip 15 but sufficiently low to retain the plurality of light sources in the central portion 20a of the enclosure 20. Thus, the light strip 15 is received in the enclosure 20 but the light sources are located and trapped between opposed boundaries, such as formed by opposed sides central portion 20a of the channel 20.

In addition, the central portion 20a of the enclosure 20 fully extends into the core 18b of light transmitting portion 18 of the elongated body 14. In this manner, the light transmitting portion 18 of the elongated body 14 straddles the central portion 20a of the enclosure 20 and the light sources direct light into the core 18b and light transmitting portion 18, as noted above. Optionally, the inwardly facing upper wall of central portion 20a may include optical structures, such as ribs or ridges, including wedge-shaped ridges, which extend along the length of enclosure 20, to further diffuse the light from the light sources.

While illustrated with round and rectangular cross-sections, the enclosure 20 and/or central portion 20a may have other cross-sections.

In another embodiment, the light transmitting portion 18 is formed from a diffused material, such as diffused silicone where the light transmitting body is sufficiently diffused so that the light strip 15 is not discernable with the possible exception of the light sources when powered, which may appear to be discrete light sources or may appear to form a continuous light. However, when not powered, the diffuse nature of the material forming light transmitting portion 18 combined with a shared color may still create a similar effect where the light assembly does not appear to be a light until the light sources are powered.

As noted above, the color of the tint and/or opacity used in the light assembly may vary to suit its particular application. For example, the outwardly facing surface 18a of light transmitting body 18 may be formed from a coating (such as by co-extrusion during the extrusion process) or may be formed by a thin film (which has the same opacity and/or color as base 16) that is post applied. Further, the bulk of elongated body may be formed from one material, such as silicone, and with the coating or film forming outwardly facing surface 18a of light transmitting body 18. The thickness of the outer layer may vary. For example, outer layer may be relatively thin, for example having a thickness in a range of about 0.0039 to 0.25 inches, such that when the light sources are powered, the outer layer or coating is sufficiently translucent allowing the light transmitting portion 18 to emit light from light assembly 12. Hence, when powered, light assembly 12 looks light a light assembly.

Referring to FIG. 6, and as noted above, one or more portions of the base may be formed with translucent or transparent material or materials (e.g., natural or diffused silicone or polymeric material) to allow a user to see the cut lines on a light strip. In an alternate embodiment, the elongate body 14 includes an interior wall 14c to fully enclose and physically separate the enclosure 20 from the exterior of the light assembly. In this manner, light assembly 12 can seal the light strip and is, therefore, can be suitable for use in moist or wet applications, 14. In applications where sealing is not material or can be done through other means, such as caulking, the interior wall could be eliminated. Either way, the cut lines of the light strip will be visible to add in the installation process.

In yet other embodiments, light transmitting portion 18 may be formed from a diffused material and/or tinted material, such as diffused and/or tinted silicone, while base 16 may be at least partially formed from an opaque material, and optionally tinted opaque material, such as opaque tinted silicone.

As noted above, the light strip may comprise a flexible tape light circuit board whose length is adjusted by cutting the tape at preset cut locations along its length. To assist an installer, the light circuit board may be visible through the mounting base 16. For example, a portion or portions of or the entire mounting base may be formed from a transparent or translucent material so that an installer can see where to cut the light circuit board when adjusting the length of the light assembly.

As noted above the light sources may comprise LEDs, and further may comprise tunable LEDs, such as RGB LEDs, RGBW LEDs, or just tunable white LEDs, which can be controlled by a controller to turn the light sources on or off, as needed, as well as adjust the color and/or intensity (lumens) of the light emitted from the light sources. For example, a suitable controller is available from Texas Instruments, Cypress Semiconductor, or Silicon Labs. In addition to the light sources, the light circuit board may also include other components, such as resistors, which are used to limit the amount of current to the LEDs, for example, when the voltage source (e.g., from the controller) does not equal to the voltage drop of the LEDs.

Further, in any of the above, when viewed from the end of the light assembly, the light transmitting surface of the outwardly facing surface may form a light pattern angle in a range of 90 to 180 degrees, a range of 100 to 150 degrees, or at least a 120 degree light pattern about the longitudinal axis of the light assembly when the light sources are powered.

As best seen in FIG. 2, elongated body 14 may have a bottom side 14d, such as a planar bottom side. Bottom side 14d may form a bearing and/or sealing surface, for example, to directly engage the web 11d of extrusion 11. Optionally, an adhesive or sealant may be located between the planar bottom side 14d and web 11d. In addition, elongated body 14 may have a channel 14e that extends into planar bottom side, and which straddles the fasteners that secure the extrusion to the RV. Further, as described, bottom side 14d may be transparent or translucent or may have a transparent or translucent portion or portion to allow an installer to see the cut lines on the light strip as noted above.

Further, as noted, enclosure 12 may be formed from different materials, with one material forming a light transmitting portion 18 and the other material forming the base 16.

As best seen in FIG. 6, the extrusions of the any of the light assembly systems may vary. Referring again to FIG. 6, light assembly system 110 includes light assembly 12 and an extrusion 111 that is configured to include (in addition to flanges 111a and 111b, which are similar to flanges 11a, 11b) additional flanges 111e and 111f so that the channel 111c in which the light assembly 12 is captured can be offset and, further, angled with respect to the RV mounting surface. For further details of the light assembly system 110 reference is made to the first embodiment.

While several forms of the invention have been shown and described in reference to several embodiments, it should be understood that one or more features of one embodiment may be combined with features of another embodiment. Further while directional terms “upper”, “lower”, “top”, and “bottom” have been used, these terms are used generally in reference to the orientations shown in the figures. As would be understood by those skilled in the art, the light assemblies may be inverted and mounted the underside of a structure.

1. A light assembly for covering an extrusion for an RV panel, the extrusion having a web, through which fasteners extend to secure the extrusion to an RV, and a pair of inwardly facing flanges that extend from the web with the pair of inwardly facing flanges having distal ends and a space between the distal ends to form an access opening to the web, the light assembly comprising:
a light strip having a plurality of light sources;
a flexible elongated body having a base for mounting said light assembly in the extrusion and a light transmitting portion joined or formed with said base, said light transmitting portion having an outwardly facing surface when mounted in the extrusion, said light strip in said elongated body and emitting light, when powered, into and through said light transmitting portion wherein light emitted from said light sources is output from said outwardly facing surface;
said flexible elongated body having recessed channels on opposed sides of the elongated body between said light transmitting portion and said base to receive the inwardly facing flanges of the extrusion; and
said base having a cross-sectional dimension being sized to be greater than the space between the ends of the inwardly facing flanges wherein when said base is inserted into the extrusion, said base will capture said flexible elongated body in the extrusion.

2. The light assembly according to claim 1, wherein said outwardly facing surface has a cross-section sized to extend over the inwardly facing flanges of the extrusion when said base of said flexible elongated body is captured in the extrusion.

3. The light assembly according to claim 2, wherein said cross-section of said outwardly facing surface is sized to fully extend over and cover the inwardly facing flanges of the extrusion when said base of said flexible elongated body is captured in the extrusion.

4. The light assembly according to claim 1, wherein said light assembly is configured to have a first state wherein said outwardly facing surface of said light transmitting body has a first color to match a color of the extrusion when said light sources on said light strip are not powered and a second state to no longer match the color of the extrusion wherein instead light is emitted from said outwardly facing surface of said light transmitting body when said light strip is powered.

5. The light assembly according to claim 1, wherein said flexible elongated body comprises a silicone elongated body.

6. The light assembly according to claim 5, wherein said outwardly facing surface of said elongated body is translucent.

7. The light assembly according to claim 6, wherein said flexible elongated body comprises first and second silicone materials, said first silicone material being substantially transparent, and said second silicone material being translucent and forming said outwardly facing surface.

8. The light assembly according to claim 7, wherein said flexible elongated body comprises first and second materials, said first material comprising a silicone material and being substantially transparent, and said second material comprising a translucent plastic, such as PVC, and forming said outwardly facing surface.

9. The light assembly according to claim 1, wherein said light strip comprises a flexible light circuit board.

10. The light assembly according to claim 1, wherein said base has a channel sized and arranged to straddle the fasteners that are used to secure the extrusion to the RV.

11. The light assembly according to claim 1, wherein said base has a pair of bearing surfaces straddling said channel.

12. A light assembly system comprising:
an extrusion for an RV panel, said extrusion having a web and a pair of inwardly facing flanges extending from said web, said web providing a surface through which fasteners extend to secure said extrusion to an RV, said pair of inwardly facing flanges having distal ends and a space between said distal ends to form an access opening to said web; and
a light assembly comprising:
a light strip having a plurality of light sources;
a flexible elongated body having a base for mounting said light assembly in said extrusion and a light transmitting portion joined or formed with said base, said light transmitting portion having an outwardly facing surface when mounted in said extrusion;
said light strip in said elongated body for emitting light into and through said light transmitting portion, wherein, when powered, light emitted from said light sources is output from said outwardly facing surface of said elongated body;
said flexible elongated body forming an upper portion and a lower portion, said lower portion including said base, and said upper portion including said outwardly facing surface, said upper portion and said lower portion each having a cross-sectional dimension greater than said space between said distal ends of said pair of inwardly facing flanges, said flexible elongated body having recessed channels on opposed sides of said elongated body between said upper portion and said lower portion, and wherein when said base is in inserted into said extrusion, said recessed channels will receive and sealingly engage said pair of inwardly facing flanges and said base will capture said flexible elongated body in said extrusion.

13. The light assembly system according to claim 12, wherein said extrusion has a colored exterior surface, and said light assembly is configured to have a first state wherein said outwardly facing surface has a first color to generally match said colored surface of said extrusion when said light sources on said light strip are not powered and a second state when said light strip is powered to no longer match said colored surface of said extrusion wherein instead light is emitted from said outwardly facing surface.

14. The light assembly system according to claim 12, wherein said outwardly facing surface of said elongated body has a cross-section sized to fully extend over and cover said inwardly facing flanges of said extrusion when said base of said flexible elongated body is captured in said extrusion.

15. The light assembly system according to claim 14, wherein said extrusion has a colored exterior surface, and said light assembly is configured to have a first state wherein said outwardly facing surface has a first color to generally match said colored surface of said extrusion when said light sources on said light strip are not powered and a second state when said light strip is powered to no longer match said colored surface of said extrusion wherein instead light is emitted from said outwardly facing surface.

16. The light assembly system according to claim 12, wherein said flexible elongated body comprises first and second materials, said first material comprising a silicone material and being substantially transparent, and said second material comprising a second transparent silicon material or a plastic, such as PVC, and said second material forming said outwardly facing surface.

17. The light assembly system according to claim 12, wherein said light strip comprises a flexible light circuit board.

18. The light assembly system according to claim 12, wherein said base has a channel sized and arranged to straddle the fasteners that are used to secure said extrusion to the RV.

19. The light assembly system according to claim 12, wherein said base has a pair of bearing surfaces straddling said channel.

20. A light assembly for covering an extrusion for an RV panel, the extrusion having a web, through which fasteners extend to secure the extrusion to an RV, and a pair of inwardly facing flanges that extend from the web with the pair of inwardly facing flanges having distal ends and a space between the distal ends to form an access opening to the web, the light assembly comprising:
a light strip having a plurality of light sources;
a flexible elongated body having a base for mounting said light assembly in the extrusion and an outwardly facing portion joined or formed with said base, said outwardly facing portion forming an outwardly facing surface when mounted in the extrusion and having a light transmitting portion, said light strip being in said elongated body and emitting light, when powered, into and through said light transmitting portion wherein light emitted from said light sources is output from said light transmitting portion;
said base having opposed outwardly facing ribs for insertion between the inwardly facing flanges of the extrusion; and
said opposed outwardly facing ribs being configured to retain said flexible elongated body in the extrusion when inserted into the extrusion between the inwardly facing flanges of the extrusion, and said base having a channel to straddle fasteners extending through the web of the extrusion.

21. The light assembly according to claim 20, wherein said cross-section of said outwardly facing portion is sized to extend over and cover at least a portion of the inwardly facing flanges of the extrusion when said base of said flexible elongated body is inserted into the extrusion.

22. The light assembly according to claim 20, wherein said base has a bottom surface to face the web of the extrusion when said base is inserted into the extrusion, and said channel extending into the bottom surface.

23. The light assembly according to claim 22, wherein said bottom surface is a planar bottom surface.

24. The light assembly according to claim 20, wherein at least a portion of said base is transparent.

25. The light assembly according to claim 20, wherein said flexible elongated body includes opposed outwardly facing ribs spaced from said outwardly facing ribs of said base to form therebetween recessed channels to receive the inwardly facing flanges of the extrusion.
